(19) United States
(12) Patent Application Publication
(10) Pub. No.: US 2009/0075164 A1
(43) Pub. Date: Mar. 19, 2009

(54) DIRECT CURRENT POWER SUPPLY AND METHOD THEREFOR

(76) Inventor: Iradj Hessabi, Las Vegas, NV (US)

Correspondence Address: WEISS & MOY PC, 4204 NORTH BROWN AVENUE, SCOTTSDALE, AZ, 85251, US

(21) Appl. No.: 11/858,051

(22) Filed: Sep. 19, 2007

(51) Int. Cl. H01M 6/28

(52) U.S. Cl. 429/125

(57) ABSTRACT

A Direct Current (DC) power supply has a body section having a plurality of chambers. The body section is formed of a non-conductive material. A pair of electrodes is placed in each of the plurality of chambers. A first electrode has a positive electromotive force and a second electrode has a negative electromotive force. The first electrode and the second electrode are placed in the chamber to form a void spaced between the first electrode and the second electrode. A liquid is placed in the void space of each chamber. Metal wires are used to connect the second electrode of each chamber with the first electrode of an adjacent chamber.

### FIELD OF THE INVENTION

This invention relates to power sources and, more specifically, to a Direct Current (DC) power supply which generates electrical power through the combination of metals in a liquid medium.

### BACKGROUND OF THE INVENTION

Electrical power generation is derived from many different technologies such as chemical, mechanical, and physical, by exchange of positive and negative electrons. The basis of the exchange of electrons may occur mechanically by exchanging of magnetic fields through turning of a rotor, friction of different loaded materials, or through the application of mechanical stress to piezoelectric device. The exchange process can also be fulfilled through a chemical medium or through naturally occurring mediums The acceleration of masses of electrons and their current in a direction is the generation of electrical power.

Presently, most electrical power is generated through the use of combustible materials like oil, gas and the like. However, generation of electrical power in this manner requires the input of some type of energy to produce electrical energy. Oil and gas are also not renewable energy sources and are in limited supplies. Oil and gas furthermore damage the environment by the production of pollutants and gases which damage the environment.

Other sources of energy such as wind, water, sunlight, and the like are renewable, but are not as efficient in producing energy. Furthermore, sunlight and wind are not continual, and thus are not used in a wide spread basis for the production of electricity.

At one time, power generation through the use of nuclear energy was seen as the future. However, the construction of nuclear power plants is extremely expensive. Furthermore, the generation of electrical energy through the use of nuclear power produces nuclear waste. At the present time, there is no safe and efficient manner to dispose of the nuclear waste.

Therefore, a need existed to provide a system and method to overcome the above problem. The system and method would provide a safe and low cost manner of producing electrical energy.

### SUMMARY OF THE INVENTION

In accordance with one embodiment of the present invention, a Direct Current (DC) power supply has a body section having a plurality of chambers. The body section is formed of a non-conductive material. A pair of electrodes is placed in each of the plurality of chambers. A first electrode has a positive electromotive force and a second electrode has a negative electromotive force. The first electrode and the second electrode are placed in the chamber to form a void spaced between the first electrode and the second electrode. A liquid is placed in the void space of each chamber. Metal wires are used to connect the second electrode of each chamber with the first electrode of an adjacent chamber.

In accordance with another embodiment of the present invention, a DC power supply has a body section having a plurality of chambers. The body section is formed of a non-conductive material. A plurality of openings is formed in a sidewall of the body section, wherein one opening is formed into each chamber. A pair of electrodes is placed in each of the plurality of chambers. A first electrode has a positive electromotive force and a second electrode has a negative electromotive force. The first electrode and the second electrode are placed in the chamber to form a void spaced between the first electrode and the second electrode. A liquid is placed in the void space of each chamber. Metal wires are used to connect the second electrode of each chamber with the first electrode of an adjacent chamber. A housing is placed over the body section for covering the body section and the openings. A positive metal contact is coupled to the first electrode of a first chamber. A negative metal contact is coupled to the second electrode of a last chamber.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an elevated front view of the Direct Current (DC) power supply of the present invention;

FIG. 2 is a front view of the DC power supply depicted in FIG. 1;

FIG. 3 is a top view of the DC power supply depicted in FIG. 1;

FIG. 4 is a bottom view of the DC power supply depicted in FIG. 1;

FIG. 5 is a cross-section view of the DC power supply with the cover in a raised position:

FIG. 6 is a cross-section view of the DC power supply with the cover in a closed position;

FIG. 7 is a perspective view of the positive and negative electrodes used in the DC power supply of the present invention.

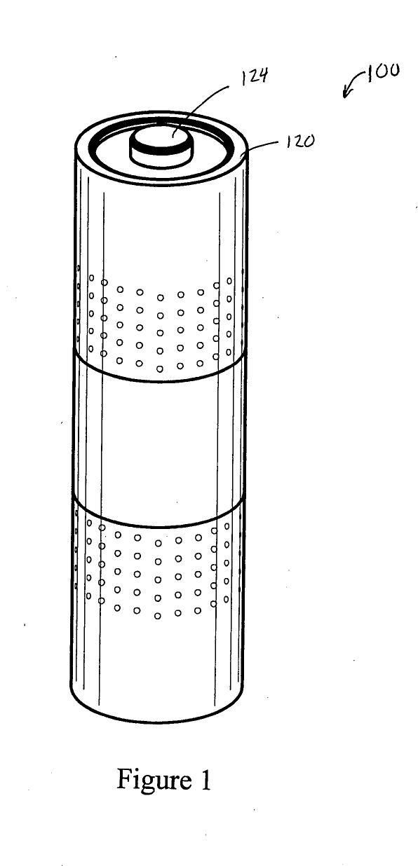

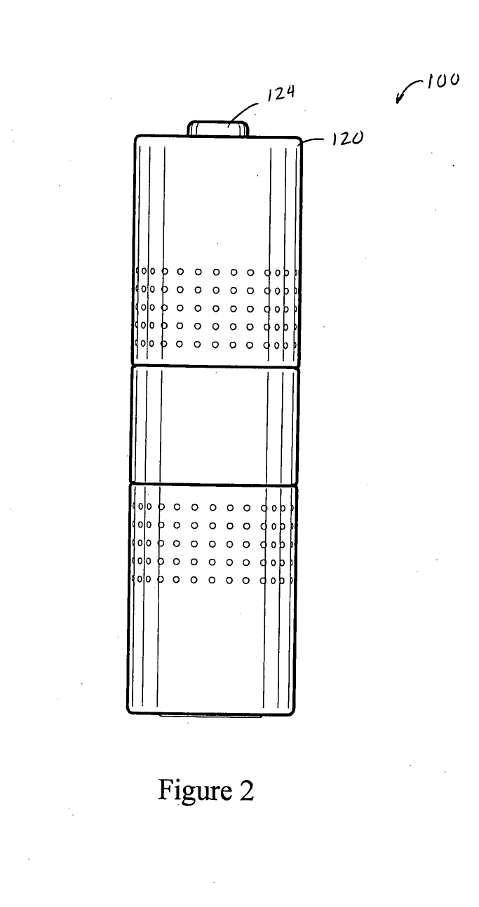

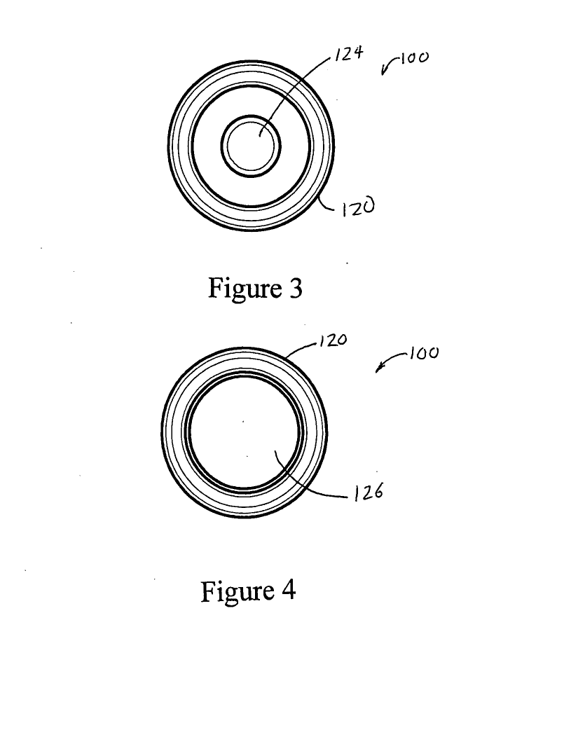

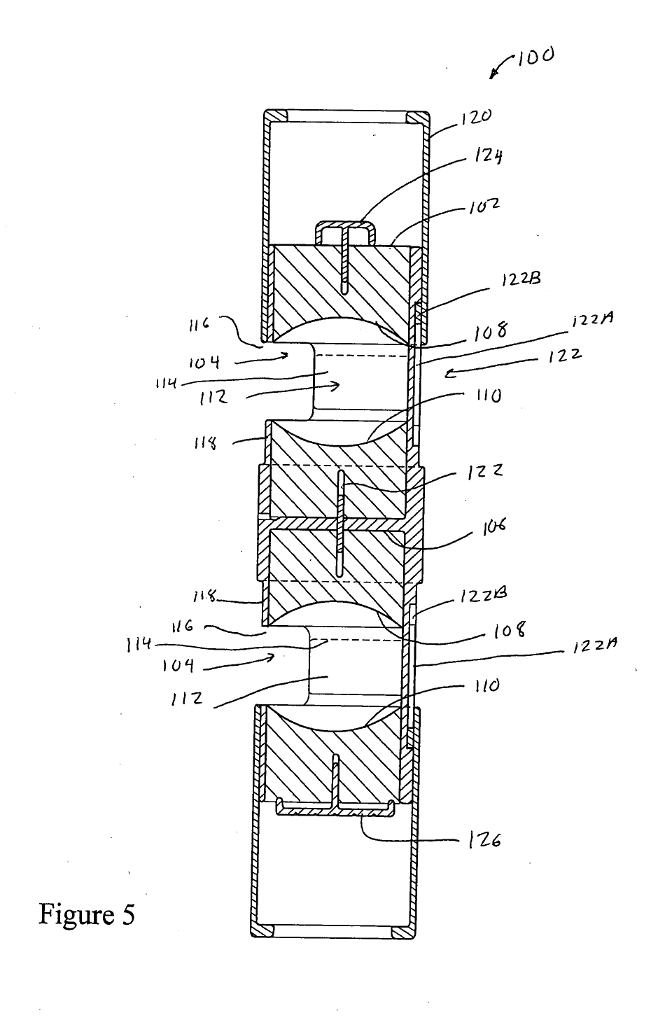

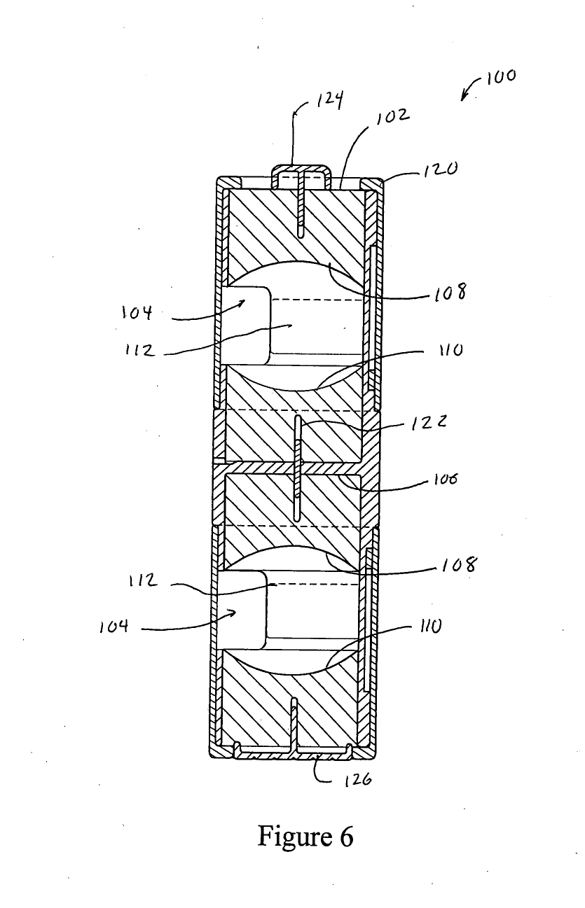

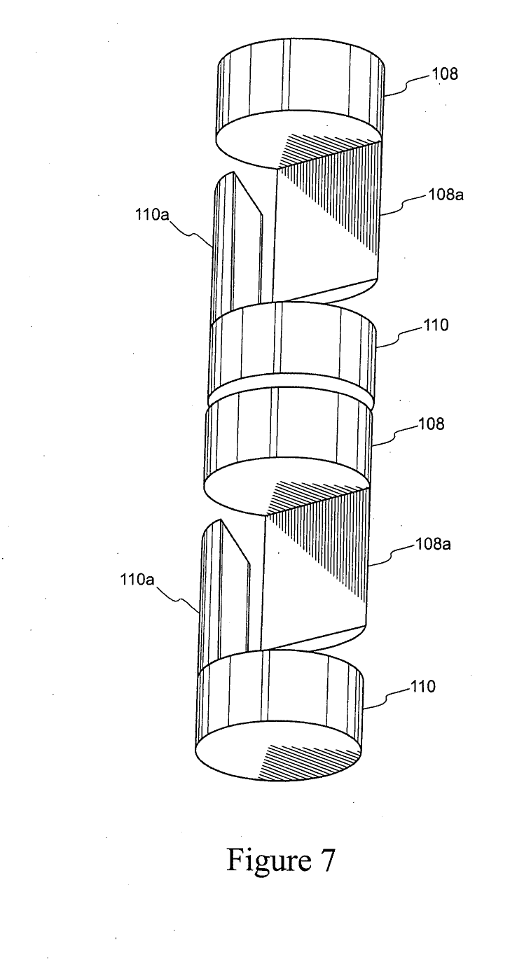

### DETAILED DESCRIPTION

With reference now to the Figures, a DC power supply 100 is shown. The DC power supply 100 has a main body unit 102. The main body unit 102 is generally formed of a non-conductive material such as plastic, ceramic, glass or the like. The listing of the above is given as an example and should not be seen as to limit the scope of the present invention. The main body unit 102 is generally a cylindrical container. The main body unit 102 will be divided into a plurality of chambers 104. In the embodiment depicted in the Figures, the main body unit 102 has two chambers 104. However, this should no be seen as to limit the present invention. In general, a splitter wall 106 is used to segment the main body unit 102 will be divided into a plurality of chambers 104. The splitter wall 106 is generally formed of the same material as the main body unit 102. Thus, the splitter wall 106 is generally formed of a non-conductive material such as plastic, ceramic, glass or the like.

Each chamber 104 will have a positive electrode 108 and a negative electrode 110 positioned therein. As shown in the Figures, the positive electrode 108 is positioned in a top area of each chamber 104. The negative electrode 110 is positioned at a bottom area of each chamber 104. In general, the splitter wall 106 is used for mounting the positive electrode 108 and the negative electrode 110 in each chamber 104 except where the electrode is being positioned in the top and bottom surfaces of the main body unit 102.

A void space 112 is formed between the positive electrode 108 and the negative electrode 110 wherein the void space 112 will have a small opening 116 formed on a sidewall 118 of the chamber 104.

The positive electrode 108 and the negative electrode 110 are formed of two different metals having naturally different electromotive forces. The positive electrode 108 will have positive electromotive forces and is generally formed out of a metal such as copper, silver, gold, or the like. The negative electrode 110 will have negative electromotive forces and is generally formed of a metal such as zinc, aluminum or the like. Each of the positive electrodes 108 and the negative electrodes 110 are generally cylindrical in shape so that the positive electrodes 108 and the negative electrodes 110 may fit within the main body unit 102. However, to increase the surface area of the positive electrodes 108 and the negative electrodes 110, each positive electrode 108 and negative electrode 110 will have a link 108A and 110A respectively. The links 108A and 110A will extend from the positive electrodes 108 and the negative electrodes 110 respectively and will be made of the same material in which the links 108A and 110A will extend from the positive electrodes 108 and the negative electrodes 110.

A metal wire 122 is used to connect the positive electrode 112 of a first chamber 110A with the negative electrode 114 of an adjoining chamber 110A. The diameter of the metal wire 122 is dependent on the number of chambers 110A in the main body unit 110. In accordance with one embodiment of the present invention, the diameter of the metal wire was approximately 0.2 to 0.4 millimeters.

As stated above, each chamber 104 will have an opening 116 formed on a sidewall 118 of the chamber 104. The opening 116 is used to insert or remove a liquid medium 114 into each chamber 104. The liquid medium 114 is used to allow the movement of electrons in the chambers 104 thus generating a Direct Current (DC). In general, any electrons which are able to move are dragged towards the positive electrode 108 and pushed away from the negative electrode 110. In accordance with one embodiment, the liquid medium 114 is generally water. However, other types of liquid mediums 114 may be used that will allow the movement of the electrons in the chambers 104. Periodic changing of the liquid medium 114 is based on usage of the DC power supply 100. In general, the liquid medium 114 should last from two to ten weeks based on usage. The changing of the liquid medium 114 is useful for cleaning the positive and negative electrodes 108 and 110 as well as for cleaning the chambers 104 of mineral deposit. The opening 116 is large enough to allow a small brush to be placed in the chamber 104 to clean the chamber 104.

In general, the liquid medium 114 will not completely fill the chamber 104. The shape of the chambers 104 is designed so that a void space will is formed of air when the chamber 104 is filled with the liquid medium 114. The void space allows the liquid medium 114 to expand which may occurred due to temperature changes.

A positive contact 124 is coupled to a positive electrode 108 located in a top chamber 104 of the main body unit 102. A negative contact 126 is coupled to a negative electrode 110 located in a bottom chamber 104 of the main body unit 102. The positive contact 124 and the negative contact 126 are similar to the contacts on a consumer battery.

A housing 120 is placed over the main body unit 102. The housing 120 is used to close the small opening 116 formed on a sidewall 118 of the chamber 104 so that the liquid medium 118 will remain in the chambers 104. By removing the housing 120, one can remove and change out the liquid medium 118. A locking device 122 is formed on the housing 120 and the main body unit 102 to secure the housing 120 to the main body unit 102. In accordance with one embodiment, the locking device 122 is a twist lock. The twist lock has an L-shaped channel 122A formed in the main body unit 102. A tab member 122B is formed in the housing 120. The housing 120 is then placed over the main body unit 102 so that the tab 122B is inserted into the L-shaped channel 122A. The housing 120 is slid completely down to cover the main body unit 102. The housing is then twisted so that the tab 122B is moved into the bottom leg of the L-shaped channel 122A thereby locking the housing 120 to cover the main body unit 102.

In accordance with one embodiment of the present invention, the housing 120 is formed of an upper housing 120A and a lower housing 120B. In this embodiment, the locking device 122 will have a pair of L-shaped channels 122A formed on the main body unit 102 (i.e., one on the upper half of the main body unit 102 and one on the lower half of the main body unit 102). A tab member 122B is formed on both the upper housing 120A and a lower housing 120B. The upper housing 120A and a lower housing 120B are then placed over the main body unit 102 so that an individual tab 122B is inserted into each of the pair of L-shaped channels 122A. The upper housing 120A and the lower housing 120B are slid completely over the main body unit 102. The upper housing 120A and a lower housing 120B are then twisted so that the tabs 122B is moved into the bottom leg of the L-shaped channels 122A thereby locking the upper housing 120A and a lower housing 120B to cover the main body unit 102.

In operation, the DC power supply 100 will have a plurality of chambers 104. Each chamber 104 will house a positive and negative electrode 108 and 110 which conduct electrons in and out of the chamber 104 via liquid medium 118, the metal wires 122, and the positive and negative contacts 124 and 126. The current of electrons from a metal with a positive electromotive force (positive electrode 108) and a second metal with negative electromotive force (negative electrode 110) in the liquid medium 118 generates a current. The current is transfer a first chamber 104 to the second chamber 104 by a wire 122 which generates measurable electrical power, In the embodiment depicted in the Figures, the chambers 104 are connected in a series combination. The series combination provides approximately 1.7 volts in average, with a current capability of approximately 2.5 milli-amperes.

While embodiments of the disclosure have been described in terms of various specific embodiments, those skilled in the art will recognize that the embodiments of the disclosure can be practiced with modifications within the spirit and scope of the claims.

What is claimed is:

1. A DC power supply comprising:
a body section having a plurality of chambers, the body section formed of a non-conductive material;
a pair of electrodes placed in each of the plurality of chambers, wherein a first electrode has a positive electromotive force and a second electrode has a negative electromotive force, the first electrode and the second electrode placed in the chamber to form a void spaced between the first electrode and the second electrode;
a liquid placed in the void space of each chamber: and
metal wires which connect the second electrode of each chamber with the first electrode of an adjacent chamber.

2. A DC power supply in accordance with claim 1 further comprising:
a positive metal contact coupled to the first electrode of a first chamber; and
a negative metal contact coupled to the second electrode of a last chamber.

3. A DC power supply in accordance with claim 1 further comprising an opening formed in each of the chambers for inserting and removing the fluid.

4. A DC power supply in accordance with claim 3 further comprising a housing placed over the body section for covering the body section and the openings.

5. A DC power supply in accordance with claim 4 wherein the housing comprises:
an upper housing for covering a top area of the body section and the openings in the top area of the body section; and
a lower housing for covering a bottom area of the body section and the openings in the bottom area of the body section.

6. A DC power supply in accordance with claim 4 further comprising a locking device coupled to the housing and the body section for securing the housing to the body section.

7. A DC power supply in accordance with claim 5 further comprising a locking device wherein the locking device comprises:
a pair of L-shaped channels, wherein a first L-shaped channel is formed on the top area of the body section, and a second L-shaped channel is formed on the bottom area of the body section; and
a pair of tab members, wherein a first tab member is formed on the upper housing, and a second tab member is formed on the lower housing;
wherein the pair of tab members engage the pair of L-shaped channels locking the upper housing and the lower housing to the body section.

8. A DC power supply in accordance with claim 1 wherein the first electrode and the second electrode each have link members to increase a surface area of the first electrode and the second electrode.

9. A DC power supply in accordance with claim 1 wherein the fluid is water.

10. A DC power supply in accordance with claim 1 wherein the first electrode is formed out of a metal comprising one of; copper, silver, gold, or combinations thereof.

11. A DC power supply in accordance with claim 1 wherein the second electrode is formed out of a metal comprising one of: zinc, aluminum or combinations thereof.

12. A DC power supply in accordance with claim 1 further comprising at least one splitter wall formed in the body section to divide the body section into the plurality of chambers.

13. A DC power supply comprising:
a body section having a plurality of chambers, the body section formed of a non-conductive material;
a plurality of openings formed in a sidewall of the body section, wherein one opening is formed into each chamber;
a pair of electrodes placed in each of the plurality of chambers, wherein a first electrode has a positive electromotive force and a second electrode has a negative electromotive force, the first electrode and the second electrode placed in the chamber to form a void spaced between the first electrode and the second electrode;
a liquid placed in the void space of each chamber;
metal wires which connect the second electrode of each chamber with the first electrode of an adjacent chamber;
a housing placed over the body section for covering the body section and the openings;
a positive metal contact coupled to the first electrode of a first chamber; and
a negative metal contact coupled to the second electrode of a last chamber.

14. A DC power supply in accordance with claim 13 further comprising a locking device coupled to the housing and the body section for securing the housing to the body section.

15. A DC power supply in accordance with claim 13 wherein the housing comprises:
an upper housing for covering a top area of the body section and the openings in the top area of the body section; and
a lower housing for covering a bottom area of the body section and the openings in the bottom area of the body section.

16. A DC power supply in accordance with claim 15 further comprising a locking device for securing the housing to the body section wherein the locking device comprises:
a pair of L-shaped channels, wherein a first L-shaped channel is formed on the top area of the body section, and a second L-shaped channel is formed on the bottom area of the body section; and
a pair of tab members, wherein a first tab member is formed on the upper housing, and a second tab member is formed on the lower housing;
wherein the pair of tab members engage the pair of L-shaped channels locking the upper housing and the lower housing to the body section.

17. A DC power supply in accordance with claim 13 wherein the first electrode and the second electrode each have link members to increase a surface area of the first electrode and the second electrode.

18. A DC power supply in accordance with claim 13 wherein the fluid is water.

19. A DC power supply in accordance with claim 13 wherein the first electrode is formed out of a metal comprising one of: copper, silver, gold, or combinations thereof.

20. A DC power supply in accordance with claim 13 wherein the second electrode is formed out of a metal comprising one of: zinc, aluminum or combinations thereof.
